(19) United States
(12) Patent Application Publication
(10) Pub. No.: US 2025/0365226 A1
(43) Pub. Date: Nov. 27, 2025

(54) COMMUNICATION SYSTEM, AND TRAFFIC INFORMATION COLLECTION METHOD

(71) Applicant: DENSO CORPORATION, Kariya-city (JP)

(72) Inventors: TAKUTO YOSHIDA, Kariya-city (JP); YASUHIRO KOTANI, Kariya-city (JP)

(21) Appl. No.: 19/178,331

(22) Filed: Apr. 14, 2025

(30) Foreign Application Priority Data
May 21, 2024 (JP) 2024-082790

(51) Int. Cl. H04L 43/0876; H04L 43/02

(52) U.S. Cl. CPC H04L 43/0876; H04L 43/02

(57) ABSTRACT

A communication system includes a relay device having a plurality of ports and configured to duplicate traffic passing through at least one of the plurality of ports, a network controller configured to monitor traffic of a data network including the relay device, and a traffic processing device having a storage unit configured to receive and store the traffic duplicated by the relay device without passing through another relay device, and a transmission unit configured to transmit traffic information regarding the duplicated traffic obtained from the storage unit to the network controller at a predetermined timing.

### CROSS REFERENCE TO RELATED APPLICATION

This application is based on Japanese Patent Application No. 2024-082790 filed on May 21, 2024, the disclosure of which is incorporated herein by reference.

### TECHNICAL FIELD

The present disclosure relates to a technology for collecting information on traffic flowing through a network.

### BACKGROUND

A real-time traffic analysis system described in a related art includes multiple programmable network switches, a network controller for managing and monitoring the multiple programmable network switches, a real-time traffic collection module, and an analysis module.

### SUMMARY

A communication system includes a relay device having a plurality of ports and configured to duplicate traffic passing through at least one of the plurality of ports, a network controller configured to monitor traffic of a data network including the relay device, and a traffic processing device having a storage unit configured to receive and store the traffic duplicated by the relay device without passing through another relay device, and a transmission unit configured to transmit traffic information regarding the duplicated traffic obtained from the storage unit to the network controller at a predetermined timing.

### BRIEF DESCRIPTION OF DRAWINGS

Objects, features and advantages of the present disclosure will become more apparent from the following detailed description made with reference to the accompanying drawings. In the drawings:

FIG. 1 is a block diagram showing a schematic configuration of a communication system according to the present embodiment;

FIG. 2 is a diagram showing the configuration of a traffic processing device according to the present embodiment;

FIG. 3 is a diagram showing the initiation of communication between ECUs in the communication system according to the present embodiment;

FIG. 4 is a diagram showing the mirroring of traffic between ECUs in the communication system according to the present embodiment;

FIG. 5 is a diagram showing a request for traffic information by the SDN controller in the communication system according to the present embodiment;

FIG. 6 is a diagram showing the transmission of traffic information to the SDN controller in the communication system according to the present embodiment;

FIG. 7 is a diagram showing the mirroring of traffic at multiple ports in the communication system according to the present embodiment;

FIG. 8 is a diagram showing the initiation of communication between ECUs in the communication system according to a reference example;

FIG. 9 is a diagram showing the mirroring of traffic between ECUs in the communication system according to a reference example;

FIG. 10 is a diagram showing a first example of the traffic information transmission process according to the present embodiment;

FIG. 11 is a diagram showing a second example of the traffic information transmission process according to the present embodiment;

FIG. 12 is a diagram showing a third example of the traffic information transmission process according to the present embodiment;

FIG. 13 is a diagram showing the network optimization process according to the present embodiment; and

FIG. 14 is a diagram showing the configuration of a relay device incorporating a traffic processing device according to another embodiment.

### DETAILED DESCRIPTION

In the above real-time traffic analysis system, the traffic information collected by the network switches is immediately transmitted to the network controller. As a result, there may be a difficulty that the network bandwidth is constantly congested due to the collected traffic information.

The present disclosure provides a technology capable of collecting traffic information while suppressing network bandwidth congestion.

According to one aspect of the present disclosure, a communication system includes: a relay device having a plurality of ports and configured to duplicate traffic passing through at least one of the plurality of ports; a network controller configured to monitor traffic of a data network including the relay device; and a traffic processing device having a storage unit configured to receive and store the traffic duplicated by the relay device without passing through another relay device, and a transmission unit configured to transmit traffic information regarding the duplicated traffic obtained from the storage unit to the network controller at a predetermined timing.

According to the communication system of one aspect of the present disclosure, the duplicated traffic by the relay device is stored in the storage unit without passing through another relay device. That is, the duplicated traffic is stored in the storage unit without using the bandwidth of the data network. Therefore, the transmission unit can transmit traffic information regarding the duplicated traffic to the network controller at a predetermined timing. Consequently, the network controller can collect traffic information while suppressing congestion in the data network.

According to another aspect of the present disclosure, a traffic information collection method includes: receiving and storing duplicated traffic passing through at least one of a plurality of ports of the relay device without passing through another relay device in a storage unit; obtaining traffic information regarding the duplicated traffic from the storage unit; and transmitting the obtained traffic information to the network controller configured to monitor traffic of the data network including the relay device at a predetermined timing.

According to the above method, the same effects as the aforementioned communication system can be achieved.

### EMBODIMENT

### 1. Configuration

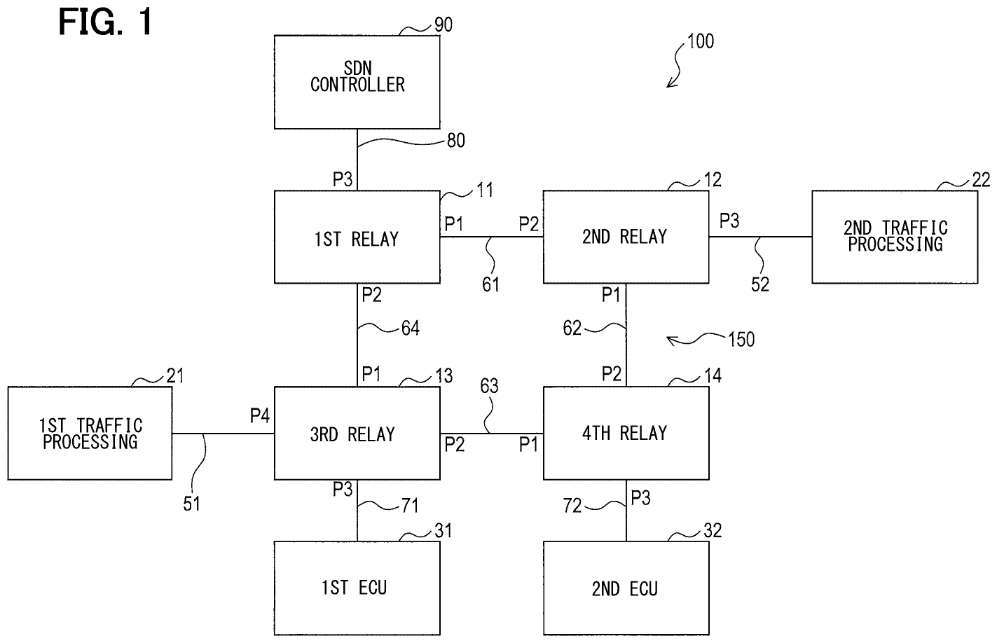

The configuration of the communication system 100 according to the present embodiment will be described with reference to FIG. 1. The communication system 100 includes a data network 150. In the present embodiment, it is assumed that the communication system 100 is mounted on a vehicle.

The data network 150 includes a first relay device 11, a second relay device 12, a third relay device 13, a fourth relay device 14, a first signal line 61, a second signal line 62, a third signal line 63, and a fourth signal line 64. The number of relay devices included in the data network 150 is not limited to four. The data network 150 may include one, two, or three relay devices, or it may include five or more relay devices.

Each of the first to fourth relay devices 11 to 14 has a first port P1, a second port P2, and a third port P3. The third relay device 13 further has a fourth port P4. The first port P1 of the first relay device 11 is connected to the second port P2 of the second relay device 12 via the first signal line 61. The first port P1 of the second relay device 12 is connected to the second port P2 of the fourth relay device 14 via the second signal line 62. The second port P2 of the first relay device 11 is connected to the first port P1 of the third relay device 13 via the fourth signal line 64. The second port P2 of the third relay device 13 is connected to the first port P1 of the fourth relay device 14 via the third signal line 63. The first to fourth signal lines 61 to 64 are, for example, signal lines conforming to the Ethernet (registered trademark) protocol.

In addition to the data network 150, the communication system 100 includes a first electronic control unit (ECU) 31, a second ECU 32, a Software Defined Network (SDN) controller 90, a first traffic processing device 21, a second traffic processing device 22, a fifth signal line 80, a sixth signal line 71, a seventh signal line 72, an eighth signal line 51, and a ninth signal line 52. The SDN controller 90 corresponds to a network controller.

The SDN controller 90 is connected to the third port P3 of the first relay device 11 via the fifth signal line 80. The fifth signal line 80 is a signal line conforming to the OpenFlow protocol, and the SDN controller 90 controls the data network 150 according to the OpenFlow protocol. Specifically, the SDN controller 90 monitors the traffic flowing through the data network 150. That is, the SDN controller 90 collects traffic information on the data network 150. Then, based on the analysis results of the traffic information, the SDN controller 90 optimizes the data network 150. Traffic refers to data transmitted and received over the data network 150, such as a frame.

Each of the first to fourth relay devices 11 to 14 is an OpenFlow switch. Each of the first to fourth relay devices 11 to 14 relays received traffic based on a flow table created by the SDN controller 90. That is, each of the first to fourth relay devices 11 to 14 determines the destination of the received traffic or discards it based on the flow table.

The first ECU 31 is connected to the third port P3 of the third relay device 13 via the sixth signal line 71. The second ECU 32 is connected to the third port P3 of the fourth relay device 14 via the seventh signal line 72. The first ECU 31 and the second ECU 32 control or manage the functions of the vehicle. In the present embodiment, the first ECU 31 manages the power state of the vehicle. For example, the power state of the vehicle includes an accessory power state, a constant power state, and an off state. The sixth and seventh signal lines 71 and 72 are, for example, signal lines conforming to the Controller Area Network (CAN) protocol. Note that three or more ECUs may be connected to the data network 150, and in-vehicle devices other than ECUs may also be connected. The ECUs and/or in-vehicle devices connected to the data network 150 communicate with other ECUs and/or other in-vehicle devices via the data network 150.

The first traffic processing device 21 is connected to the fourth port P4 of the third relay device 13 via the eighth signal line 51. The second traffic processing device 22 is connected to the third port P3 of the fourth relay device 14 via the ninth signal line 52. The eighth and ninth signal lines 51 and 52 are, for example, signal lines conforming to the Ethernet protocol.

Each of the first to fourth relay devices 11 to 14 is equipped with a port mirroring function. The port mirroring function may duplicate all traffic passing through the port, or it may filter and select traffic passing through the port and duplicate the selected traffic.

In the present embodiment, the second and third relay devices 12 and 13 duplicate the traffic flowing through the data network 150 so that the SDN controller 90 can collect traffic information. The second and third relay devices 12 and 13 then transmit the duplicated traffic directly to the first and second traffic processing devices 21 and 22 without passing through other relay devices.

Specifically, the second relay device 12 duplicates the traffic passing through each of the first and second ports P1 and P2 and directly transmits the duplicated traffic from the third port P3 to the second traffic processing device 22. Alternatively, the second relay device 12 may duplicate only the traffic passing through the first port P1 and directly transmit the duplicated traffic from the third port P3 to the second traffic processing device 22. The third relay device 13 duplicates the traffic passing through each of the first to third ports P1 to P3 and directly transmits the duplicated traffic from the fourth port P4 to the first traffic processing device 21. Alternatively, the third relay device 13 may duplicate only the traffic passing through the third port P3 and directly transmit the duplicated traffic from the fourth port P4 to the first traffic processing device 21.

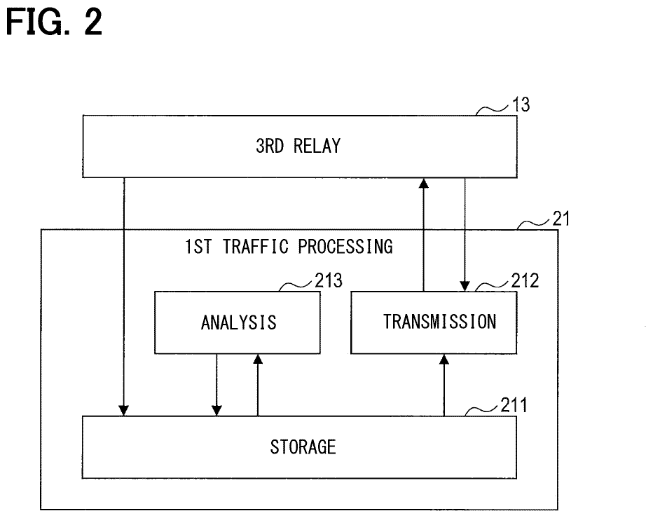

As shown in FIG. 2, the first traffic processing device 21 includes a storage unit 211, a transmission unit 212, and an analysis unit 213. The second traffic processing device 22 has the same configuration as the first traffic processing device 21.

The storage unit 211 stores the duplicated traffic received via the fourth port P4 of the third relay device 13. The analysis unit 213 obtains and analyzes the duplicated traffic stored in the storage unit 211 and stores the analysis results in the storage unit 211. The transmission unit 212 transmits the traffic information obtained from the storage unit 211 to the SDN controller 90 at a predetermined timing. The traffic information includes raw data of the duplicated traffic (e.g., frames), traffic processed by a predetermined method, statistical information of traffic over a predetermined period, analysis results, etc. The predetermined method (process) may include batch processing, compression processing, etc. The predetermined timing is when the traffic volume of the data network 150 is relatively low. That is, the predetermined timing is when the bandwidth utilization rate of the communication path from the first traffic processing device 21 or the second traffic processing device 22 to the SDN controller 90 is relatively low. Alternatively, the predetermined timing is when the usage rate of the storage unit 211 is close to the upper limit.

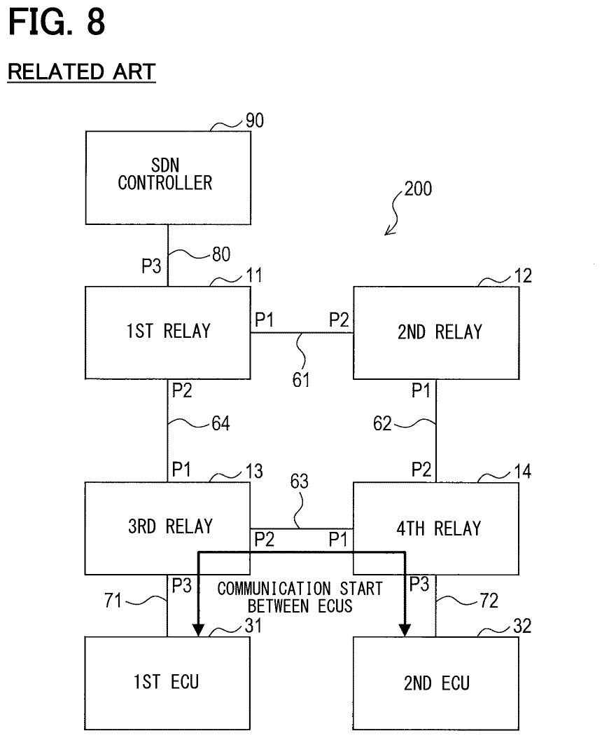

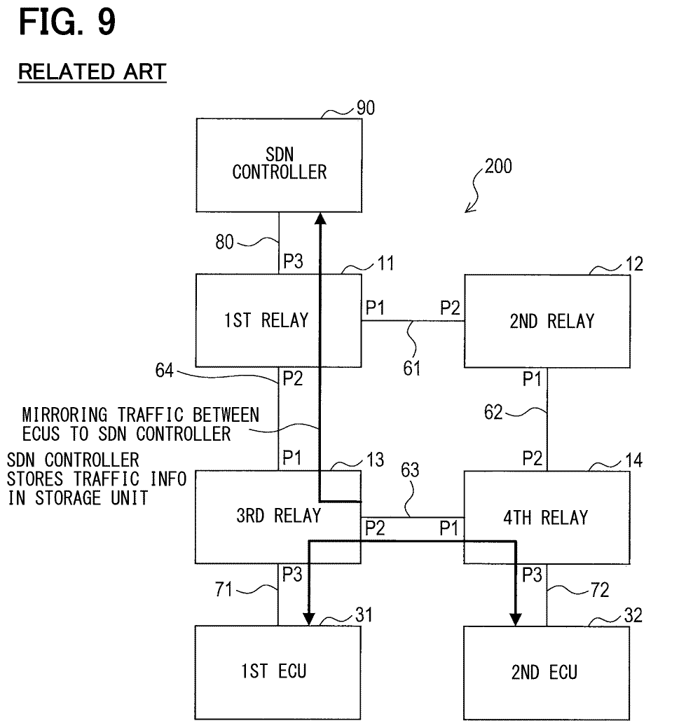

FIGS. 8 and 9 show a communication system 200 according to a reference example. The communication system 200 differs from the communication system 100 in that it does not include the first and second traffic processing devices 21 and 22. When the first ECU 31 starts communication with the second ECU 32, the traffic passes through the third relay device 13 and the fourth relay device 14. The third relay device 13 duplicates the traffic passing through the second port P2 and transmits it to the first port P1. That is, the third relay device 13 transmits the duplicated traffic immediately to the SDN controller 90 via the first relay device 11. The SDN controller 90 stores the received traffic in the storage unit 211.

Therefore, if the transmission timing of the duplicated traffic coincides with a time when the traffic volume on the communication path is relatively high (i.e., when the bandwidth utilization rate of the communication path is relatively high), the bandwidth of the communication path may become congested. For example, if the duplicated traffic is transmitted while an ECU connected to the first relay device 11 is communicating with an ECU connected to the third relay device 13, the bandwidth of the communication path may cause congestion.

In contrast, in the present embodiment, the duplicated traffic is temporarily stored in the storage unit 211 of the first traffic processing device 21 and is not transmitted to the SDN controller 90 immediately after duplication. Therefore, the transmission timing of the duplicated traffic can be shifted from the timing when the bandwidth utilization rate of the communication path is relatively high. In other words, the transmission timing of the duplicated traffic can be shifted from the relatively high timing of the bandwidth utilization rate of the communication path.

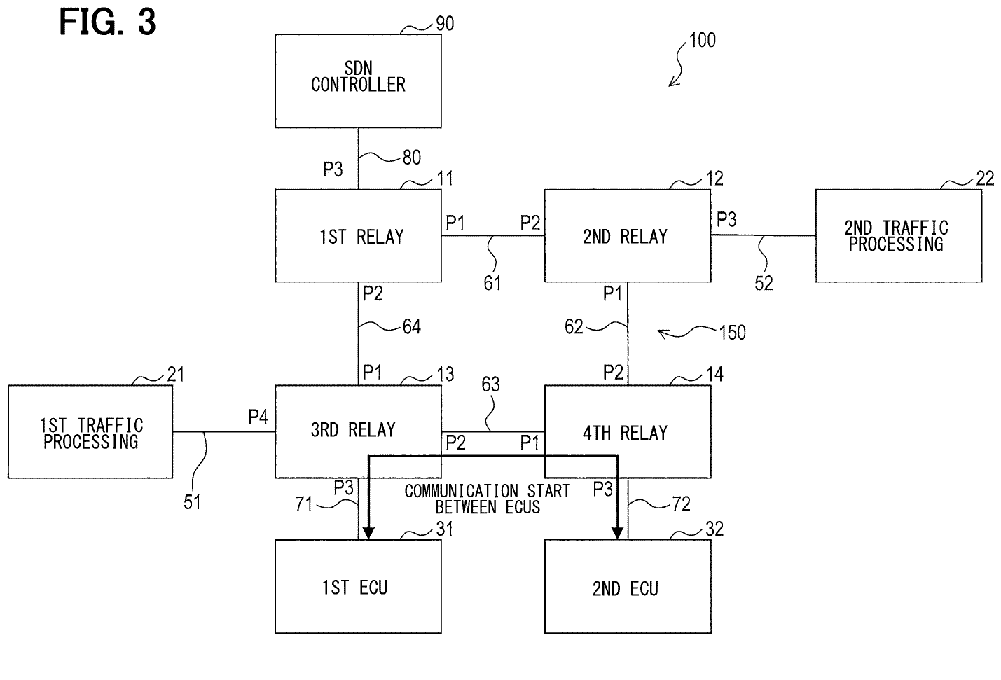

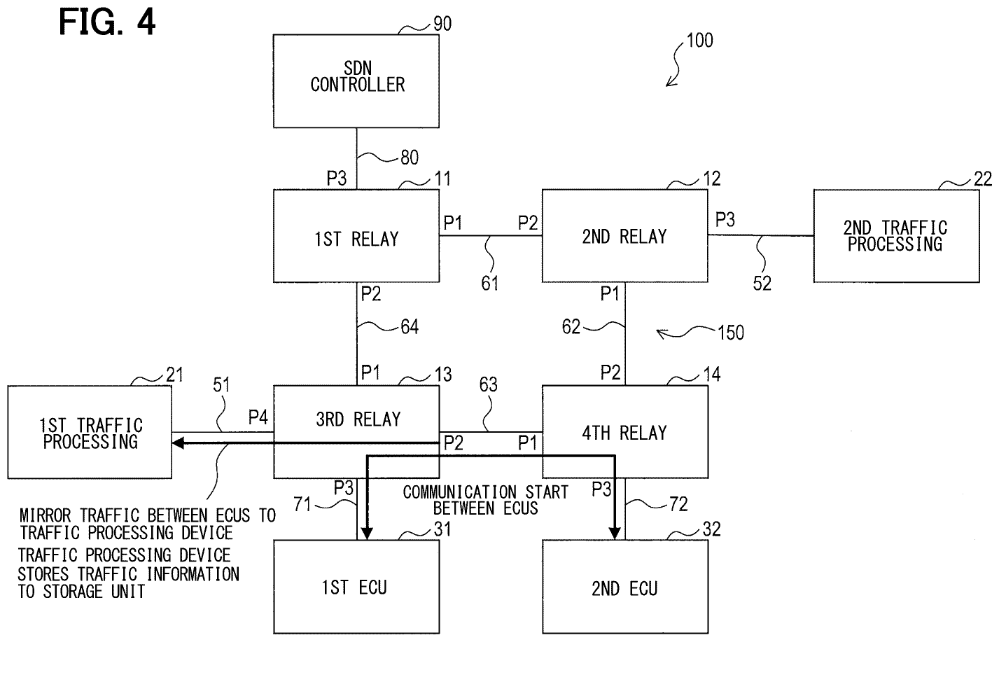

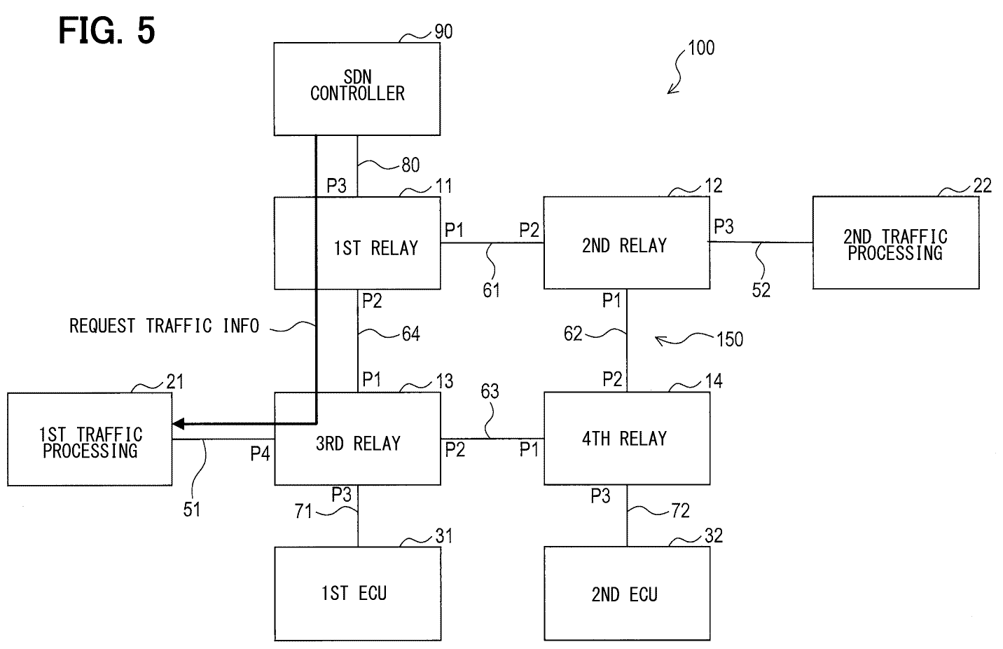

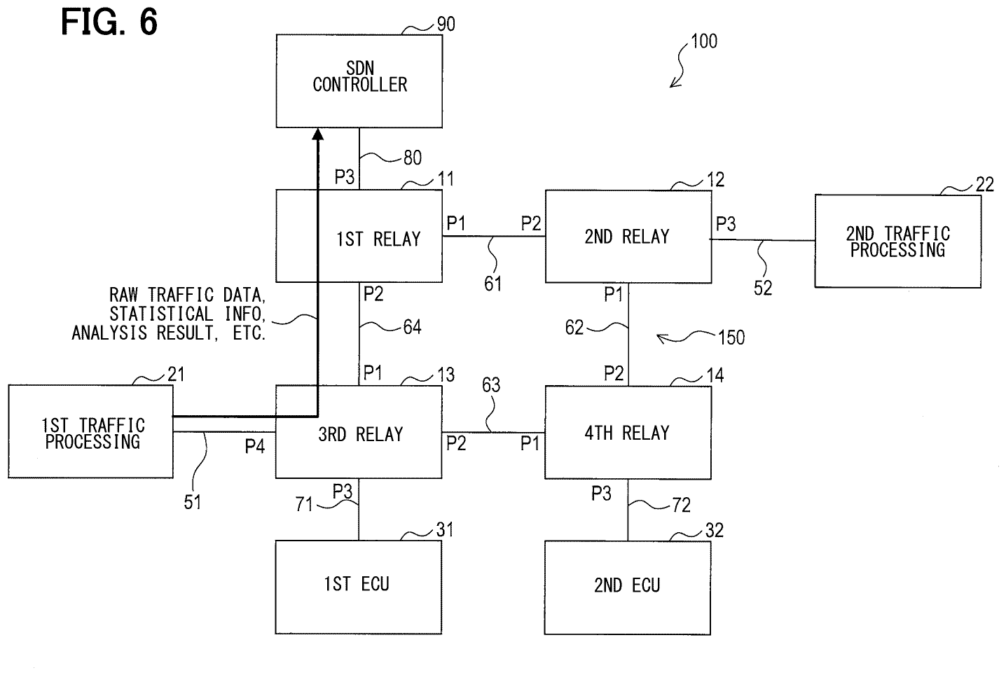

FIGS. 3 to 6 show the flow of traffic information when the first ECU 31 starts communication with the second ECU 32 in the present embodiment. When the first ECU 31 starts communication with the second ECU 32, the traffic passes through the third relay device 13 and the fourth relay device 14. The third relay device 13 duplicates the traffic input to or output from the second port P2 and transmits the duplicated traffic from the fourth port P4 to the first traffic processing device 21. The first traffic processing device 21 receives the duplicated traffic and stores it in the storage unit 211.

The SDN controller 90 requests traffic information from the first traffic processing device 21 when the bandwidth utilization rate of the communication path between the first relay device 11 and the third relay device 13 is relatively low. Specifically, the SDN controller 90 obtains the bandwidth utilization rate of the communication path detected by the first relay device 11 or the third relay device 13 and sends a signal requesting traffic information when the obtained bandwidth utilization rate is below the first threshold.

Alternatively, the SDN controller 90 obtains the power state of the vehicle from the first ECU 31 and sends a signal requesting traffic information when the power state of the vehicle is in a predetermined state. The predetermined state is a state in which the traffic volume of the data network 150 is estimated to be relatively low or a state in which a decrease in the communication speed of the data network 150 is acceptable. For example, the predetermined state is the accessory (ACC) state. When the power state of the vehicle is in the ACC state, the vehicle is stationary. When the vehicle is stationary, the traffic volume on the data network 150 is estimated to be lower compared to when the vehicle is running. Additionally, when the vehicle is stationary, the impact of a decrease in the communication speed of the data network 150 is lower compared to when the vehicle is running.

When the first traffic processing device 21 receives a signal requesting traffic information from the SDN controller 90, the transmission unit 212 obtains the traffic information from the storage unit 211. The transmission unit 212 then transmits the obtained traffic information to the SDN controller 90 via the eighth signal line 51, the third relay device 13, the fourth signal line 64, the first relay device 11, and the fifth signal line 80.

Additionally, the transmission unit 212 may reduce the data amount of the traffic information before transmitting it to the SDN controller 90. Specifically, the transmission unit 212 may select and transmit only the necessary traffic information to the SDN controller 90. In other words, the transmission unit 212 may select and discard unnecessary traffic information and transmit only the necessary traffic information to the SDN controller 90. For example, the transmission unit 212 may select and transmit only frames with specific destinations to the SDN controller 90. The transmission unit 212 may also batch process or compress the traffic information before transmitting it to the SDN controller 90. For example, the transmission unit 212 may convert the traffic information into statistical information or compress it using zip compression before transmitting it to the SDN controller 90.

Furthermore, the transmission unit 212 may determine the transmission timing by itself and transmit the traffic information to the SDN controller 90. That is, the transmission unit 212 may determine whether the bandwidth utilization rate of the communication path is below the first threshold and transmit the traffic information to the SDN controller 90 when the bandwidth utilization rate is below the first threshold. Alternatively, the transmission unit 212 may determine whether the power state of the vehicle is in the predetermined state and transmit the traffic information to the SDN controller 90 when the power state of the vehicle is in the predetermined state.

Additionally, the transmission unit 212 may transmit the traffic information to the SDN controller 90 when the usage rate of the storage unit 211 exceeds the second threshold. Since the duplicated traffic is temporarily stored in the storage unit 211, traffic over a predetermined period can be collected and processed. Accordingly, the data amount of the traffic information transmitted to the SDN controller 90 is reduced, thereby preventing congestion of the communication path regardless of the bandwidth utilization rate of the communication path.

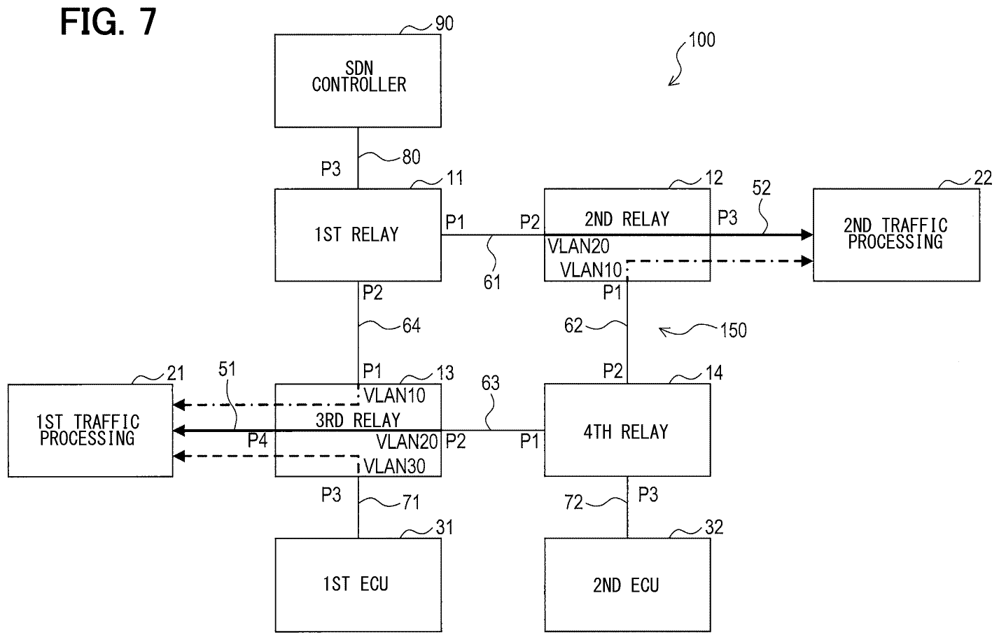

FIG. 7 shows a situation where traffic is mirrored at multiple ports. The second relay device 12 communicates with the first relay device 11 via the second port P2 and with the fourth relay device 14 via the first port P1. The second relay device 12 duplicates the traffic passing through each of the first and second ports P1 and P2, adds a VLAN tag to the duplicated traffic, and transmits it from the third port P3 to the second traffic processing device 22. The VLAN tag is an identifier that determines through which port of the second relay device 12 the traffic passed. The second traffic processing device 22 determines through which port the traffic passed based on the VLAN tag. For example, the second traffic processing device 22 may perform statistical processing of the traffic for a predetermined period for each port.

The third relay device 13 communicates with the first relay device 11 via the first port P1, with the fourth relay device 14 via the second port P2, and with the first ECU 31 via the third port P3. The third relay device 13 duplicates the traffic passing through each of the first, second, and third ports P1, P2, and P3, adds a VLAN tag to the duplicated traffic, and transmits it from the fourth port P4 to the first traffic processing device 21. The VLAN tag is an identifier that determines through which port of the third relay device 13 the traffic passed. The first traffic processing device 21 determines through which port the traffic passed based on the VLAN tag.

### 2. Processing

### 2-1. First Example of Traffic Information Transmission Processing

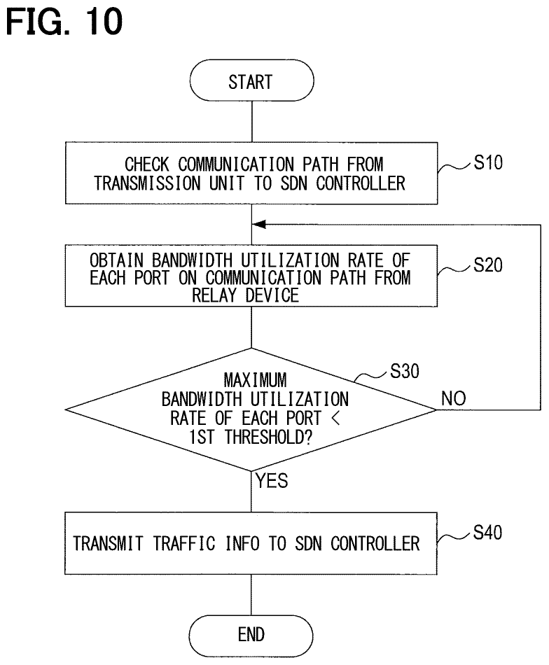

A first example of the traffic information transmission processing executed by the transmission unit 212 of the first traffic processing device 21 will be described with reference to the flowchart in FIG. 10. In this transmission processing, the transmission unit 212 determines the transmission timing of the traffic information.

In S10, the transmission unit 212 checks the communication path from the transmission unit 212 to the SDN controller 90.

Next, in S20, the transmission unit 212 obtains the bandwidth utilization rate of the communication path confirmed in S10 from the third relay device 13. Specifically, the transmission unit 212 obtains the bandwidth utilization rate of each port on the communication path from the third relay device 13. If there are other relay devices on the communication path, the third relay device 13 obtains the bandwidth utilization rate of the ports of the other relay devices from those relay devices. The third relay device 13 then transmits the bandwidth utilization rate of its own ports along with the bandwidth utilization rate of the ports of the other relay devices to the first traffic processing device 21.

Next, in S30, the transmission unit 212 determines whether the maximum value of the bandwidth utilization rates of the ports obtained in S20 is below the first threshold. The first threshold is, for example, 50%. If the transmission unit 212 determines that the maximum value of the bandwidth utilization rates is above the first threshold, it returns to the processing of S20. If the transmission unit 212 determines that the maximum value of the bandwidth utilization rates is below the first threshold, it proceeds to the processing of S40.

In S40, the transmission unit 212 transmits the traffic information obtained from the storage unit 211, or traffic information that has been further processed, to the SDN controller 90. As described later in S130, the first traffic processing device 21 may delete the transmitted traffic information and the duplicated traffic on which the traffic information was based, from the storage unit 211.

### 2-2. Second Example of Traffic Information Transmission Processing

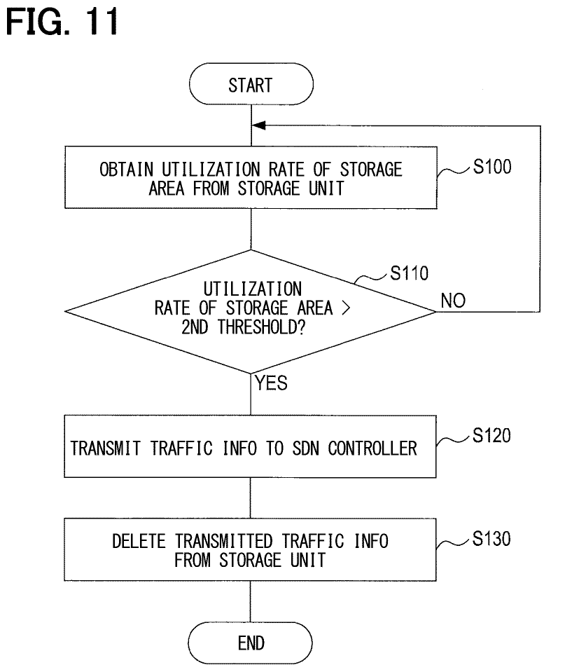

A second example of the traffic information transmission processing executed by the transmission unit 212 will be described with reference to the flowchart in FIG. 11. In this transmission processing, the transmission unit 212 determines the transmission timing of the traffic information.

In S100, the transmission unit 212 obtains the usage rate of the storage area from the storage unit 211 of the first traffic processing device 21. Next, in S110, the transmission unit 212 determines whether the usage rate of the storage area obtained in S100 exceeds the second threshold. The second threshold is, for example, 90%. If the transmission unit 212 determines that the usage rate of the storage area is below the second threshold, it returns to the processing of S100. If the transmission unit 212 determines that the usage rate of the storage area exceeds the second threshold, it proceeds to the processing of S120.

Next, in S120, the transmission unit 212 transmits the traffic information obtained from the storage unit 211, or traffic information that has been further processed, to the SDN controller 90. Next, in S130, the first traffic processing device 21 deletes the transmitted traffic information and the duplicated traffic on which the traffic information was based, from the storage unit 211.

### 2-3. Third Example of Traffic Information Transmission Processing

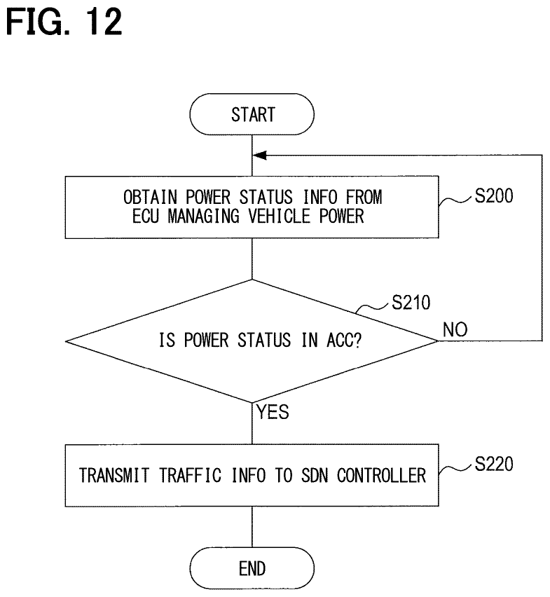

A third example of the traffic information transmission processing executed by the transmission unit 212 will be described with reference to the flowchart in FIG. 12. In this transmission processing, the transmission unit 212 determines the transmission timing of the traffic information.

In S200, the transmission unit 212 obtains the power state from the first ECU 31, which manages the vehicle's power. Next, in S210, the transmission unit 212 determines whether the power state obtained in S200 is ACC. If the transmission unit 212 determines that the power state is not ACC, it returns to the processing of S200. If the transmission unit 212 determines that the power state is ACC, it proceeds to the processing of S220.

In S220, the transmission unit 212 transmits the traffic information obtained from the storage unit 211, or traffic information that has been further processed, to the SDN controller 90. As described in S130, the first traffic processing device 21 may delete the transmitted traffic information and the duplicated traffic on which the traffic information was based, from the storage unit 211.

### 2-4. Network Optimization Process

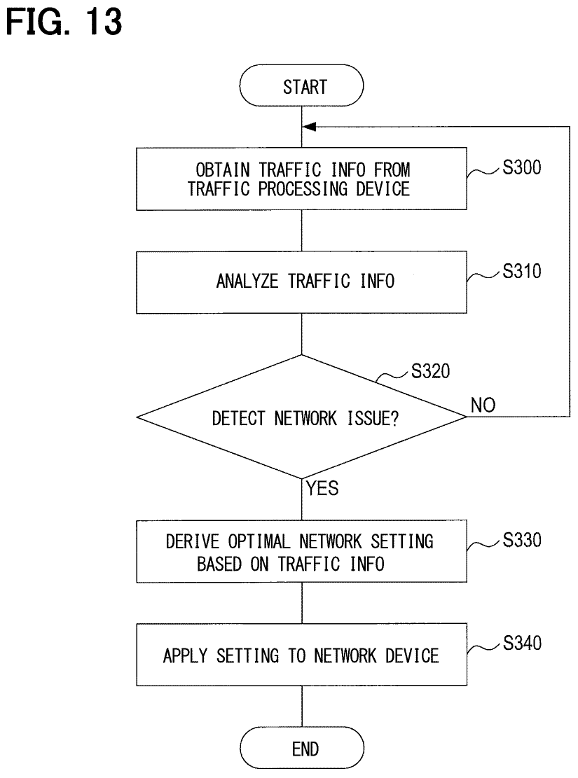

The network optimization process executed by the SDN controller 90 will be described with reference to the flowchart in FIG. 13.

In S300, the SDN controller 90 obtains traffic information from the first traffic processing device 21 and/or the second traffic processing device 22. Next, in S310, the SDN controller 90 analyzes the traffic information obtained in S300.

Next, in S320, the SDN controller 90 determines whether it has detected any issues (e.g., operations that need improvement) in the data network 150. If the SDN controller 90 determines that no issues have been detected, it returns to the processing of S300. If the SDN controller 90 determines that issues have been detected, it proceeds to the processing of S330.

In S330, the SDN controller 90 derives settings to optimize the data network 150 based on the traffic information analyzed in S310.

Next, in S340, the SDN controller 90 applies the derived settings to each device included in the data network 150. In the present embodiment, the SDN controller 90 applies the optimization settings to the first to fourth relay devices 11 to 14.

According to the first embodiment described in detail above, the following effects are achieved. According to the communication system 100, the traffic duplicated by the third relay device 13 is stored in the storage unit 211 of the first traffic processing device 21 without passing through the first, second, and fourth relay devices 11, 12, and 14. In other words, the duplicated traffic is stored in the storage unit 211 without using the bandwidth of the data network 150. Therefore, the transmission unit 212 can transmit traffic information, including the duplicated traffic and/or traffic to which predetermined processing has been applied, to the SDN controller 90 at a predetermined timing. Thus, the SDN controller 90 can collect traffic information while suppressing congestion in the data network 150.

The analysis unit 213 can analyze the duplicated traffic over a predetermined period and transmit the analysis results to the SDN controller 90. For example, the analysis unit 213 can select necessary traffic from the duplicated traffic and transmit the selected traffic information to the SDN controller 90. This further suppresses congestion in the data network 150.

The transmission unit 212 transmits traffic information to the SDN controller 90 when the bandwidth utilization rate of each port on the communication path is below the first threshold, thereby suitably suppressing congestion in the data network 150.

The transmission unit 212 transmits traffic information to the SDN controller 90 when the usage rate of the storage area of the storage unit 211 exceeds the second threshold. This prevents the storage unit 211 from running out of capacity and being unable to store the duplicated traffic. Additionally, by transmitting traffic information to which processing such as compression has been applied to the SDN controller 90, the transmission unit 212 can suppress congestion in the data network 150 regardless of the bandwidth utilization rate of each port on the communication path.

The transmission unit 212 transmits traffic information to the SDN controller 90 when the power state of the vehicle is ACC. This allows the transmission unit 212 to transmit traffic information to the SDN controller 90 based on the power state, in situations where the usage rate of each port on the communication path is estimated to be relatively low or where a decrease in communication speed is acceptable.

The SDN controller 90 can optimize the data network 150 based on the analysis results of the traffic information.

### Other Embodiments

The embodiments of the present disclosure have been described above in detail, but the present disclosure is not limited to the above-described embodiments and can be implemented in various modified forms.

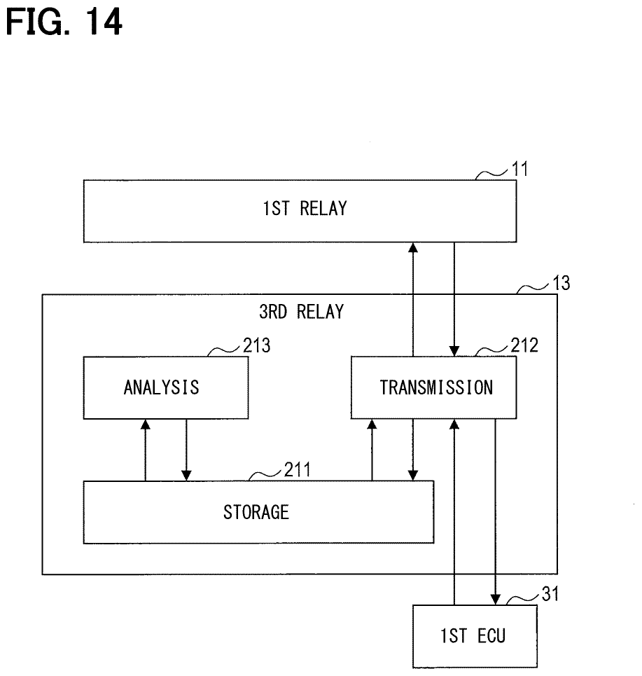

(a) In the above embodiment, the first and second traffic processing devices 21 and 22 are provided separately from the first to fourth relay devices 11 to 14. However, the first traffic processing device 21 and/or the second traffic processing device 22 may be built into any of the first to fourth relay devices 11 to 14. For example, as shown in FIG. 14, the third relay device 13 may include the storage unit 211, the transmission unit 212, and the analysis unit 213. In this case, the third relay device 13 duplicates the traffic flowing through the first to third ports P1, P2, and P3 and stores it in the storage unit 211. The transmission unit 212 transmits the traffic information to the SDN controller 90. Additionally, the transmission unit 212 sends and receives frames between the first relay device 11, the fourth relay device 14, and the first ECU 31.

(b) In the above embodiment, the communication system 100 is assumed to be mounted on a vehicle, but the communication system 100 does not necessarily have to be mounted on a vehicle. The communication system 100 may be mounted on a mobile body other than a vehicle or may be placed in a building. When the communication system 100 is mounted on something other than a vehicle, the SDN controller 90 or the transmission unit 212 determines the transmission timing of the traffic information based on the bandwidth utilization rate of the communication path and/or the usage rate of the storage area of the storage unit 211.

(c) In the above embodiment, the transmission timing of the traffic information is determined based on any one of the three conditions: the bandwidth utilization rate of the communication path, the usage rate of the storage area of the storage unit 211, and the power state of the vehicle. However, the transmission timing may be determined based on a combination of multiple conditions among the three. For example, the traffic information may be transmitted to the SDN controller 90 when the bandwidth utilization rate of the communication path is below the first threshold and the usage rate of the storage area of the storage unit 211 exceeds the second threshold. Additionally, the traffic information may be transmitted to the SDN controller 90 when the power state of the vehicle is ACC and the usage rate of the storage area of the storage unit 211 exceeds the second threshold.

(d) In the above embodiment, the communication system 100 includes two traffic processing devices to duplicate the traffic of all four relay devices. However, each relay device may be equipped with its own traffic processing device.

(e) In the above embodiment, after the transmission unit 212 transmits the traffic information obtained from the storage unit 211 or traffic information that has been further processed, to the SDN controller 90, the first traffic processing device 21 deletes the transmitted traffic information and the duplicated traffic on which the traffic information was based from the storage unit 211. However, the present disclosure is not limited to this. For example, after the transmission unit 212 transmits the traffic information obtained from the storage unit 211 or traffic information that has been further processed, to the SDN controller 90, the first traffic processing device 21 may delete the transmitted traffic information and the duplicated traffic on which the traffic information was based from the storage unit 211 upon receiving a receipt confirmation signal from the SDN controller 90. Additionally, the relay device to which the traffic processing device is connected or built-in may delete the transmitted traffic information and the duplicated traffic on which the traffic information was based, from the storage unit 211 upon receiving the settings for optimizing the data network transmitted from the SDN controller 90.

(f) In the above embodiment, the data network 150 with a ring topology including the first relay device 11, the second relay device 12, the third relay device 13, the fourth relay device 14, the first signal line 61, the second signal line 62, the third signal line 63, and the fourth signal line 64 is described. However, the data network 150 is not limited to a ring topology. Other network topologies such as a mesh topology may also be used.

(g) The multiple functions possessed by one component in the above embodiment may be realized by multiple components, or one function possessed by one component may be realized by multiple components. Additionally, multiple functions possessed by multiple components may be realized by one component, or one function realized by multiple components may be realized by one component. Furthermore, some parts of the configuration of the above embodiment may be omitted. Additionally, at least part of the configuration of the above embodiment may be added to or replaced with the configuration of another embodiment.

(h) In addition to the communication system described above, the present disclosure can also be realized in various forms such as a traffic processing device or relay device included in the communication system, a program for making a computer function as the traffic processing device or relay device, a non-transitory tangible recording medium such as a semiconductor memory recording the program, and a traffic information collection method.

What is claimed is:

1. A communication system comprising:
a relay device having a plurality of ports and configured to duplicate traffic passing through at least one of the plurality of ports;
a network controller configured to monitor traffic of a data network including the relay device; and
a traffic processing device having a storage unit configured to receive and store the traffic duplicated by the relay device without passing through another relay device, and a transmission unit configured to transmit traffic information regarding the duplicated traffic obtained from the storage unit to the network controller at a predetermined timing.

2. The communication system according to claim 1, wherein
the traffic processing device further includes an analysis unit configured to analyze the duplicated traffic obtained from the storage unit and store an analysis result in the storage unit,
wherein
the traffic information includes the analysis result.

3. The communication system according to claim 1, wherein
the relay device is configured to detect a bandwidth utilization rate of a communication path from the relay device to the network controller, and
the transmission unit is configured to transmit the traffic information to the network controller when the utilization rate detected by the relay device is below a first threshold.

4. The communication system according to claim 1, wherein
the transmission unit is configured to transmit the traffic information to the network controller when a utilization rate of the storage unit exceeds a second threshold.

5. The communication system according to claim 1, wherein
the relay device, the network controller, and the traffic processing device are mounted on a vehicle,
the relay device is connected to an electronic control unit configured to manage a power state of the vehicle, and
the transmission unit is configured to transmit the traffic information to the network controller when the power state of the vehicle obtained from the electronic control unit is in a predetermined state.

6. The communication system according to claim 1, wherein
the data network includes a plurality of devices including the relay device, and
the network controller is configured to
derive a setting to optimize the data network based on an analysis result of the traffic information received and
apply the derived setting on the plurality of devices.

7. The communication system according to claim 1, wherein
the traffic processing device is configured to delete the duplicated traffic, which is a basis of the traffic information, from the storage unit after the transmission unit has transmitted the traffic information to the network controller.

8. The communication system according to claim 2, wherein
the traffic processing device is configured to discard the duplicated traffic, which has been a basis of the analysis result, from the storage unit when the analysis result is stored in the storage unit.

9. A traffic information collection method comprising:
receiving and storing duplicated traffic passing through at least one of a plurality of ports of a relay device without passing through another relay device in a storage unit;
obtaining traffic information regarding the duplicated traffic from the storage unit; and
transmitting the obtained traffic information to a network controller configured to monitor traffic of a data network including the relay device at a predetermined timing.
